(19) United States
(12) Patent Application Publication
(10) Pub. No.: US 2026/0260605 A1
(43) Pub. Date: Sep. 3, 2026

(54) DISPLAY PANEL AND DISPLAY APPARATUS

(71) Applicants: Yunnan Invensight Optoelectronics Technology Co., Ltd., Yunnan (CN); BOE Technology Group Co., Ltd., Beijing (CN)

(72) Inventors: Zhicheng GUO, Beijing (CN); Qingshan SHAN, Beijing (CN); Shengji YANG, Beijing (CN); Junyan YANG, Beijing (CN); Pengcheng LU, Beijing (CN); Xiao BAI, Beijing (CA); Yun ZHU, Beijing (CN); Chao PU, Beijing (CN); Lida LI, Beijing (CN)

(21) Appl. No.: 18/836,029

(22) PCT Filed: Nov. 9, 2023
(86) PCT No.: PCT/CN2023/130619

§ 371 Date: Aug. 6, 2024

(30) Foreign Application Priority Data
Dec. 26, 2022 (CN) 202211674257.6

(51) Int. Cl. G09G 3/3225

(52) U.S. Cl. CPC G09G 3/3225; G09G 2300/0426; G09G 2330/021; G09G 2330/04; G09G 2330/12

(57) ABSTRACT

Provided is a display panel. In the display panel, the pixel driving circuit is indirectly coupled to the external power supply through the protection circuit. In the protection circuit, the protection sub-circuit controls, based on a received first power supply signal and a received second power supply signal, the flow direction of the external power supply signal provided by the external power supply. The control sub-circuit transmits the switch control signal to the switch sub-circuit based on the first power supply signal, the second power supply signal, and the external power supply signal, such that the switch sub-circuit controls the connection/disconnection of the external power supply and the pixel driving circuit.

### CROSS-REFERENCE TO RELATED APPLICATIONS

This application is a U.S. national stage of international application No. PCT/CN2023/130619, filed on Nov. 9, 2023, which claims priority to Chinese Patent Application No. 202211674257.6, filed on Dec. 26, 2022, and entitled “DISPLAY PANEL AND DISPLAY APPARATUS,” the disclosures of which are incorporated herein by reference in their entireties.

### TECHNICAL FIELD

The present disclosure relates to the field of display technologies, and in particular, relates to a display panel and a display apparatus.

### BACKGROUND

Silicon-based organic light emitting diode (OLED) panel is a display panel that integrates a large number of silicon-based OLEDs on a small size (e.g., 2 inches) silicon substrate. The silicon-based OLED panel has advantages of self-illumination, low power consumption, miniaturization, and high resolution, and the silicon-based OLED panel is often applied to an augmented reality device or a virtual reality device.

Currently, the silicon-based OLED panel generally includes: a silicon-based integrated circuit (IC) and a plurality of silicon-based OLEDs, wherein the silicon-based IC is also referred to as a pixel driving circuit. The silicon-based IC is coupled to the plurality of silicon-based OLEDs, and the silicon-based IC is configured to drive the plurality of silicon-based OLEDs to emit light, such that the silicon-based OLED panel displays. Before the silicon-based OLED panel is released, a high-voltage fuse mechanism is input to the silicon-based IC through a peripheral circuit including an external power supply, such that correction information including brightness, color spot and display algorithm is solidified into the silicon-based OLED panel. This process can be referred to as a one-time program (OTP) action.

### SUMMARY

Embodiments of the present disclosure provide a display panel and a display device. The technical solutions are as follows.

Some embodiments provide a display panel. The display panel includes: a pixel driving circuit and a protection circuit, wherein the protection circuit is coupled to the pixel driving circuit and an external power supply, and the protection circuit is configured to receive an external power supply signal provided by the external power supply and transmit the external power supply signal to the pixel driving circuit, wherein the external power supply includes a first electrode and a second electrode; and the protection circuit includes: a protection sub-circuit, a control sub-circuit, and a switch sub-circuit;
the protection sub-circuit is coupled to the first power supply terminal, a second power supply terminal, and the first electrode and the second electrode of the external power supply, the second electrode of the external power supply is further coupled to the second power supply terminal, and the protection sub-circuit is configured to control a flow direction of the external power supply signal based on a first power supply signal provided by the first power supply terminal, a second power supply signal provided by the second power supply terminal, and the external power supply signals;
the control sub-circuit is coupled to the first power supply terminal, the second power supply terminal, a control terminal of the switch sub-circuit, and the first electrode of the external power supply; and the control sub-circuit is configured to transmit a switch control signal to the control terminal of the switch sub-circuit based on the first power supply signal, the second power supply signal and the external power supply signal; and
an input terminal of the switch sub-circuit is coupled to the first electrode of the external power supply through the control sub-circuit, an output terminal of the switch sub-circuit is coupled to the pixel driving circuit, and the switch sub-circuit is configured to control connection/disconnection between the external power supply and the pixel driving circuit based on the switch control signal.

In some embodiments, a voltage of the first power supply signal is greater than a voltage of the second power supply signal, the voltage of the first power supply signal is not less than an upper limit value of a voltage required for normal operation of the pixel driving circuit, and the voltage of the first power supply signal is not greater than a lower limit value of the voltage required for the normal operation of the pixel driving circuit;
the protection sub-circuit is configured to: control the external power supply signal to be output to the pixel driving circuit in the case that a voltage of the external power supply signal is within a range of the voltages required for the normal operation; control the external power supply signal to be output from the first power supply terminal in the case that the voltage of the external power supply signal is not within the range of the voltages required for the normal operation and greater than the voltage of the first power supply signal; and control the external power supply signal to be output to the external power supply in the case that the voltage of the external power supply signal is not within the range of the voltages required for the normal operation and less than the voltage of the second power supply signal;
the control sub-circuit is configured to: transmit a switch control signal at a first potential to the control terminal of the switch sub-circuit based on the first power supply signal, the second power supply signal and the external power supply signal in the case that a current of the external power supply signal is not within a range of currents required for the normal operation of the pixel driving circuit; and transmit a switch control signal at a second potential to the control terminal of the switch sub-circuit based on the first power supply signal, the second power supply signal and the external power supply signal in the case that the current of the external power supply signal is within the range of the currents required for the normal operation of the pixel driving circuit; and
the switch sub-circuit is configured to control the external power supply to be disconnected to the pixel driving circuit based on the switch control signal at the first potential, and control the external power supply to connect to the pixel driving circuit based on the switch control signal at the second potential.

In some embodiments, the protection sub-circuit includes: an overvoltage protection diode and an undervoltage protection diode; wherein a positive electrode of the overvoltage protection diode is coupled to the first electrode of the external power supply, and a negative electrode of the overvoltage protection diode is coupled to the first power supply terminal; and a positive electrode of the undervoltage protection diode is coupled to the second electrode of the external power supply, and both the positive electrode of the undervoltage protection diode and the second electrode of the external power supply are coupled to the second power supply terminal.

In some embodiments, the control sub-circuit includes: a detecting unit and a primary feedback unit; wherein two terminals of the detecting unit are respectively coupled to the first electrode of the external power supply and the input terminal of the switch sub-circuit, and the detecting unit is configured to detect a current of the external power supply signal; and the primary feedback unit is coupled to the two terminals of the detecting unit, the first power supply terminal, the second power supply terminal and a control terminal of the switch sub-circuit, and the primary feedback unit is configured to generate a switch control signal based on the first power supply signal, the second power supply signal, and the current of the external power supply signal, and transmit the switch control signal to the control terminal of the switch sub-circuit.

In some embodiments, the detecting unit includes: a sampling resistor; wherein a first end of the sampling resistor is coupled to the first electrode of the external power supply, and a second end of the sampling resistor is coupled to the input terminal of the switch sub-circuit.

In some embodiments, the primary feedback unit includes: a first differential amplifier and a first resistor; wherein a positive input terminal and a negative input terminal of the first differential amplifier are coupled to the two terminals of the detecting unit, a power supply terminal of the first differential amplifier is coupled to the first power supply terminal and the second power supply terminal, an output terminal of the first differential amplifier is coupled to a first end of the first resistor, and a second end of the first resistor is coupled to the control terminal of the switch sub-circuit.

In some embodiments, the control sub-circuit further includes: a switch unit; wherein the switch unit is coupled to an enabling power supply terminal, the primary feedback unit and the control terminal of the switch sub-circuit, the switch unit is configured to receive a switch signal, and control the control terminal of the switch sub-circuit to be connected to the enabling power supply terminal or control the control terminal of the switch sub-circuit to be connected to the primary feedback unit based on the switch signal, and the switch sub-circuit is further configured to control the external power supply to be disconnected to the pixel driving circuit based on an enabling power supply signal provided by the enabling power supply terminal.

In some embodiments, the switch unit includes: a single pole double throw switch; wherein a stationary contact of the single pole double throw switch is coupled to the control terminal of the switch sub-circuit, and two movable contacts of the single pole double throw switch are respectively coupled to the primary feedback unit and the enabling power terminal.

In some embodiments, the control sub-circuit further includes: a secondary feedback unit; wherein the secondary feedback unit is coupled between the primary feedback unit and the control terminal of the switch sub-circuit, the secondary feedback unit is further coupled to the first power supply terminal, the second power supply terminal and a third power supply terminal, and the secondary feedback unit is configured to perform buck process on the switch control signal generated by the primary feedback unit based on the external power supply signal, the first power supply signal, the second power supply signal and a third power supply signal provided by the third power supply terminal, and transmit a switch control signal performed with the buck process to the control terminal of the switch sub-circuit.

In some embodiments, the secondary feedback unit includes: a threshold setting subunit and a threshold control subunit; wherein the threshold setting subunit is coupled to the second power supply terminal, the third power supply terminal and the threshold control subunit, the threshold setting subunit is configured to transmit a reference power supply signal to the threshold control subunit based on the second power supply signal and the external power supply signal, wherein a potential of the reference power supply signal is greater than a potential of the switch control signal; and the threshold control subunit is further coupled to the first power supply terminal, the second power supply terminal, the primary feedback unit and the control terminal of the switch sub-circuit, and the threshold control subunit is configured to perform the buck process on the switch control signal generated by the primary feedback unit based on the first power supply signal, the second power supply signal, and the reference power supply signal, and transmit the switch control signal performed with the buck process to the control terminal of the switch sub-circuit.

In some embodiments, the threshold setting subunit includes: a plurality of divided resistors coupled to each other; wherein at least one of the plurality of divided resistors is a variable resistor, the plurality of divided resistors are coupled to the threshold control subunit, one part of the plurality of divided resistors are coupled to the second power supply terminal, and the other part of the plurality of divided resistors are coupled to the third power supply terminal.

In some embodiments, the threshold setting subunit includes: a first divided resistor and a second divided resistor, wherein the second divided resistor is a variable resistor; wherein a first end of the first divided resistor is coupled to the third power supply terminal, a second end of the first divided resistor is coupled to the threshold control subunit, the third power supply terminal is further coupled to the first electrode of the external power supply, and the third power supply signal is the external power supply signal; a first end of the second divided resistor is coupled to the second power supply terminal, and a second end of the second divided resistor is coupled to the threshold control subunit; and the second end of the first divided resistor is coupled to the second end of the first divided resistor.

In some embodiments, the threshold control subunit includes: a second differential amplifier and a second resistor; wherein a positive input terminal of the second differential amplifier is coupled to the threshold setting subunit, a negative input terminal of the second differential amplifier is coupled to the primary feedback unit, a power supply terminal of the second differential amplifier is coupled to the first power supply terminal and the second power supply terminal, an output terminal of the second differential amplifier is coupled to a first end of the second resistor, and a second end of the second resistor is coupled to the control terminal of the switch sub-circuit.

In some embodiments, the switch sub-circuit includes: a switch transistor and a third resistor; wherein a gate of the switch transistor is coupled to the control sub-circuit as the control terminal of the switch sub-circuit, a first electrode of the switch transistor is coupled to the first electrode of the external power supply through the control sub-circuit as the input terminal of the switch sub-circuit, and a second electrode of the switch transistor is coupled to the pixel driving circuit as the output terminal of the switch sub-circuit; and a first end of the third resistor is coupled to the gate of the switch transistor, and a second end of the third resistor is coupled to the first electrode of the switch transistor.

In some embodiments, the pixel driving circuit includes: a one-time program module; wherein the protection circuit is coupled to the one-time program module, and the protection circuit is configured to transmit the external power supply signal to the one-time program module.

Some embodiments provide a display apparatus. The display apparatus includes: a display panel as described above, and a plurality of pixels disposed on the display panel, wherein the pixel driving circuit in the display panel is coupled to the plurality of pixels, and the pixel driving circuit is configured to drive the plurality of pixels to emit light.

### BRIEF DESCRIPTION OF DRAWINGS

For clearer illustration of the technical solutions in embodiments of the present disclosure, accompanying drawings required for describing the embodiments are briefly introduced hereinafter. It is apparent that the accompanying drawings described hereinafter merely illustrate some embodiments of the present disclosure, and those of ordinary skill in the art may derive other drawings from these accompanying drawings without creative efforts.

FIG. 1 is a schematic diagram of a circuit structure of a display panel according to some embodiments of the present disclosure;

FIG. 2 is a schematic diagram of a circuit structure of another display panel according to some embodiments of the present disclosure;

FIG. 3 is a schematic diagram of a normal operation of a protection sub-circuit according to some embodiments of the present disclosure; the

FIG. 4 is a schematic diagram of an operation of a protection sub-circuit in an undervoltage state according to some embodiments of the present disclosure; the

FIG. 5 is a schematic diagram of an operation of a protection sub-circuit in an overvoltage state according to some embodiments of the present disclosure;

FIG. 6 is a schematic diagram of a circuit structure of yet another display panel according to some embodiments of the present disclosure;

FIG. 7 is a schematic diagram of a circuit structure of a still another display panel according to some embodiments of the present disclosure;

FIG. 8 is a schematic diagram of a circuit structure of a still another display panel according to some embodiments of the present disclosure;

FIG. 9 is a schematic diagram of a circuit structure of a still another display panel according to some embodiments of the present disclosure;

FIG. 10 is a schematic diagram of a circuit structure of a still another display panel according to some embodiments of the present disclosure;

FIG. 11 is a schematic diagram of a circuit structure of a still another display panel according to some embodiments of the present disclosure;

FIG. 12 is a schematic diagram of normal operations of various circuits according to some embodiments of the present disclosure;

FIG. 13 is a schematic diagram of operations of various circuits in an overcurrent state according to some embodiments of the present disclosure;

FIG. 14 is a block diagram of a circuit according to some embodiments of the present disclosure;

FIG. 15 is a block diagram of another circuit according to some embodiments of the present disclosure;

FIG. 16 is a block diagram of a structure of an overall circuit inside a display panel according to a related art;

FIG. 17 is a block diagram of a structure of an overall circuit inside a display panel according to some embodiments of the present disclosure;

FIG. 18 is a schematic structural diagram of a display apparatus according to some embodiments of the present disclosure.

### DETAILED DESCRIPTION

For clearer descriptions of the objectives, technical solutions, and advantages of the present disclosure, embodiments of the present disclosure are described in detail hereinafter with reference to the accompanying drawings.

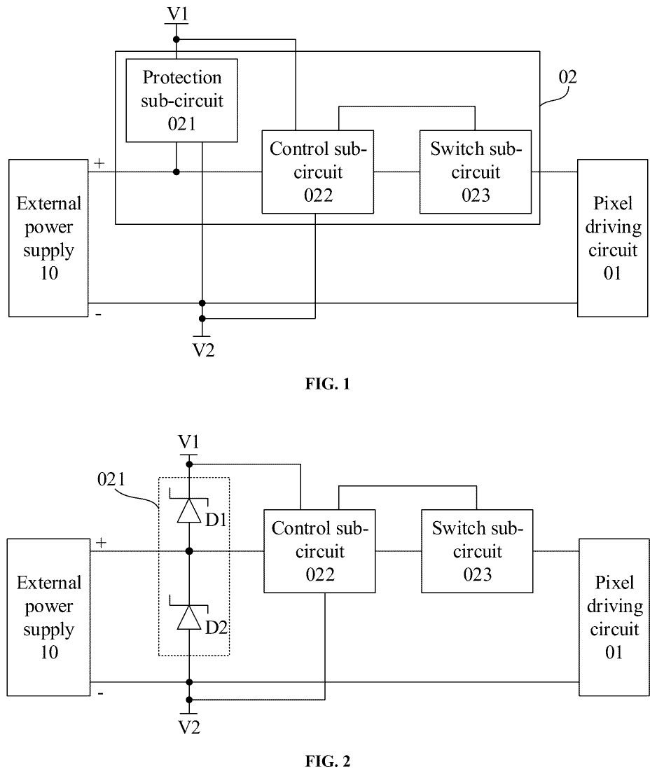

FIG. 1 is a schematic diagram of a structure of a display panel according to some embodiments of the present disclosure. As shown in FIG. 1, the display panel includes: a pixel driving circuit 01 and a protection circuit 02.

The protection circuit 02 is coupled to the pixel driving circuit 01 and an external power supply (PWR) 10, and the protection circuit 02 is configured to receive an external power supply signal provided by the external power supply 10 and transmit the external power supply signal to the pixel driving circuit 01. That is, the pixel driving circuit 01 can receive the external power supply signal transmitted by the protection circuit 02 by being indirectly coupled to the external power supply 01 through the protection circuit 02.

In some embodiments, the protection circuit 02 can be coupled to the external power supply 10 through a power input pin (also referred to as a pin). In the case that the display panel is a silicon-based OLED display panel, the pixel driving circuit 01 is also referred to as a silicon-based IC, and the pixel driving circuit 01 can include an OTP module, wherein the OTP module is indirectly coupled to the external power supply 10 through the protection circuit 02 to receive the external power supply signal. Correspondingly, the external power supply signal is a voltage input for an OTP action. The power input pin is also referred to as an OTP input pin, and abbreviated as an OTP PWR.

With respect to a related technology that the OTP module and the external power supply 10 are direct coupled, because the related technology simply specifies voltage limits of the external power supply signal, once a voltage misalignment occurs due to an influence of a spike voltage, a surge or a static electricity, an internal structure of the silicon IC is damaged. In addition, in the case that the external power supply 10 does not limit a current, the internal structure of the silicon-based IC is damaged when the current is too large, and the internal structure of the silicon-based IC is even burned in serious cases. By setting the protection circuit 02 between the pixel driving circuit 01 and the external power supply 10, the embodiments of the present disclosure can avoid the problem that the internal structure of the pixel driving circuit 01 is damaged or even burned due to an abnormal voltage or an excessive current of the external power supply signal provided by the external power supply 10, thereby protecting the pixel driving circuit 01.

Referring to FIG. 1, it can be seen that in the embodiments of the present disclosure, the external power supply 10 includes a first electrode and a second electrode. Among the first electrode and the second electrode, one electrode is a positive (+) electrode and the other electrode is a negative (−) electrode. The embodiments of the present disclosure are illustrated schematically with the first electrode being the positive electrode and the second electrode being the negative electrode. The protection circuit 02 includes: a protection sub-circuit 021, a control sub-circuit 022, and a switch sub-circuit 023.

The protection sub-circuit 021 is coupled to a first power supply terminal V1, a second power supply terminal V2, and the first electrode and the second electrode of the external power supply 10. The second electrode of the external power supply 10 is further coupled to the second power supply terminal V2. That is, referring to FIG. 1, the protection sub-circuit 021 is coupled to the second electrode of the external power supply 10, and both the protection sub-circuit 021 and the second electrode of the external power supply 10 are coupled to the second power supply terminal V2. The protection sub-circuit 021 is configured to control a flow direction of an external power supply signal based on a first power supply signal provided by the first power terminal V1, a second power supply signal provided by the second power terminal V2 and the external power supply signal.

For example, a voltage of the first power supply signal and a voltage of the second power supply signal are flexibly set based on a voltage required for a normal operation of the pixel driving circuit 01 (e.g., a voltage within an OTP power range), such that the external power supply signal can be controlled to transmit to the pixel driving circuit 01 when a voltage of the external power supply signal is within the voltage range required for the normal operation, thereby realizing an overvoltage protection and an undervoltage protection of the pixel driving circuit 01. Accordingly, the protection sub-circuit 021 is referred to as an overvoltage and undervoltage protection part.

The control sub-circuit 022 is coupled to the first power supply terminal V1, the second power supply terminal V2, a control terminal (not shown in the figure) of the switch sub-circuit 023, and the first electrode of the external power supply 10. The control sub-circuit 022 is configured to transmit a switch control signal to the control terminal of the switch sub-circuit 023 based on the first power supply signal, the second power supply signal and the external power supply signal.

For example, the control sub-circuit 022 generates a switch control signal by amplifying, based on the first power supply signal and the second power supply signal, a voltage reflected by a current of an acquired external power supply signal, and transmits the switch signal to the control terminal of the switch sub-circuit 023. In some embodiments, the control sub-circuit 022 generates a turn-off control signal in the case that the current of the external power supply signal is not within the range of currents required for the normal operation of the pixel driving circuit 01 and greater than an upper limit value of the range of currents required for the normal operation of the pixel driving circuit 01, i.e., an overcurrent condition occurs in the external power supply 10. The control sub-circuit 022 generates a turn-on control signal in the case that the current of the external power supply signal is within the range of currents required for the normal operation of the pixel driving circuit 01, i.e., the overcurrent condition does not occur in the external power supply 10.

In some embodiments, the turn-off control signal and the turn-on control signal are two switch control signals with different potentials. For example, in the case that the switch sub-circuit 023 includes a P-type transistor that opens in response to a low potential and closes in response to a high potential, a potential of the turn-off control signal is greater than a potential of the turn-on control signal. In the case that the switch sub-circuit 023 includes an N-type transistor that opens in response to a high potential and closes in response to a low potential, the potential of the turn-off control signal is less than the potential of the turn-on control signal.

An input terminal (not shown in the figure) of the switch sub-circuit 023 is coupled to the first electrode of the external power supply 10 through the control sub-circuit 022, and an output terminal (not shown in the figure) of the switch sub-circuit 023 is coupled to the pixel driving circuit 01. That is, the input terminal of the switch sub-circuit 023 is indirectly coupled to the external power supply 10 by being coupled to the control sub-circuit 02 coupled to the external power supply 10. On this basis, it can be considered that the control sub-circuit 022 and the switch sub-circuit 023 are connected in series between the external power supply 10 and the pixel driving circuit 01, such that the pixel driving circuit 01 is indirectly coupled to the external power supply 10. The switch sub-circuit 023 is configured to control connection/disconnection between the external power supply 10 and the pixel driving circuit 01 based on the switch control signal.

For example, the switch sub-circuit 023 controls the external power supply 10 to be uncouple to the pixel driving circuit 01 based on the turn-off control signal from the control sub-circuit 022. In this case, the external power supply signal provided by the external power supply 10 cannot be transmitted to the pixel driving circuit 01. The switch sub-circuit 023 controls the external power supply 10 to be connected to the pixel driving circuit 01 based on the turn-on control signal from the control sub-circuit 022. In this case, the external power supply signal provided by the external power supply 10 can be transmitted to the pixel driving circuit 01. Combined with the above description of the turn-off control signal and the turn-on control signal, it can be seen that because the turn-off control signal is a switch control signal generated under an overcurrent condition, and the turn-on control signal is a switch control signal generated under a non-overcurrent condition, overcurrent protection of the pixel driving circuit 01 can be realized on the premise of ensuring normal operation of the display panel. Accordingly, the switch sub-circuit 023 is also referred to as an overcurrent control part.

It should be noted that, referring to FIG. 1, the second electrode of the external power supply 10 may be directly coupled to the pixel driving circuit 01. That is, the pixel driving circuit 01 may be indirectly coupled to the positive electrode of the external power supply 10 through the control sub-circuit 022 and the switch sub-circuit 023. A signal line by which the pixel driving circuit 01 is indirectly coupled to the positive electrode of the external power supply 10 is referred to as a first connection line, and a signal line by which the pixel driving circuit 01 is directly coupled to the negative electrode of the external power supply 10 is referred to as a second connection line, wherein the first connection line and the second connection line form a power supply signal transmission path. It can be considered that the protection sub-circuit 021 is coupled to both the first connection line and the second connection line, thereby realizing an overvoltage protection and an undervoltage protection. The protection sub-circuit 021 may be coupled between the control sub-circuit 022 and the external power supply 10 as shown in FIG. 1. In this case, the external power supply signal flows, under the flow control of the protection sub-circuit 021, to the pixel driving circuit 01 through the control sub-circuit 022 and the switch sub-circuit 023. In some embodiments, the protection sub-circuit 021 is further coupled between the control sub-circuit 022 and the protection sub-circuit 023. In this case, the external power supply signal flows, under the flow control of the protection sub-circuit 021, to the pixel driving circuit 01 only through the switch sub-circuit 023.

In summary, the embodiments of the present disclosure provide the display panel. The display panel includes the pixel driving circuit and the protection circuit, wherein the protection circuit indirectly couples the pixel driving circuit to the external power supply. The protection circuit includes the protection sub-circuit, the control sub-circuit, and the switch sub-circuit. The protection sub-circuit controls the flow direction of the external power supply signal provided by the external power supply based on the first power supply signal and the second power supply signal. In this way, by flexibly setting the first power supply signal and the second power supply signal, the external power supply signal can flow to the pixel driving circuit only when there is no overvoltage or undervoltage, thereby realizing the overvoltage protection and the undervoltage protection for the pixel driving circuit. The control sub-circuit transmits the switch control signal to the switch sub-circuit based on the first power supply signal, the second power supply signal, and the external power supply signal to enable the switch sub-circuit to control the connection/disconnection between the external power supply and the pixel driving circuit. In this way, by flexibly setting the first power supply signal and the second power supply signal, the external power supply can be controlled to be connected to the pixel driving circuit only when there is no overcurrent, and the external power supply signal is transmitted to the pixel driving circuit, thereby realizing the overcurrent protection for the pixel driving circuit. The embodiments can avoid damage to the pixel driving circuit.

In some embodiments, the voltage of the first power supply signal is greater than the voltage of the second power supply signal, the voltage of the first power supply signal is not less than (i.e., greater than or equal to) an upper limit value of the voltages required for the normal operation of the pixel driving circuit 01, and the voltage of the first power supply signal is not greater than (i.e., less than or equal to) a lower limit value of the voltages required for the normal operation of the pixel driving circuit 01.

In some embodiments, with respect to the OTP module, the voltages required for the normal operation of the pixel driving circuit 01 refer to voltages in a normal range required to be burned into the OTP module. The voltages are generally between 7.25 volts (V) and 7.75V. On this basis, the voltage of the first power supply signal can be 7.75V, and the first power terminal V1 can be a VCC power supply terminal. The voltage of the second power supply signal can be 0, and the second power terminal V2 can be GND.

Based on the above-described embodiments, the protection sub-circuit 021 in the embodiments of the present disclosure is configured to: control the external power supply signal to output from the first power supply terminal V1 in the case that the voltage of the external power supply signal (e.g., 16V) is not within the range of the voltages required for the normal operation of the pixel driving circuit 01 and greater than the voltage of the first power supply signal (e.g., 7.75V), that is, in the case that the overvoltage occurs in the external power supply 10.

For example, the first power supply terminal V1 is generally coupled to an external appliance to receive the first power supply signal provided by the external appliance. Correspondingly, in the case that the external power supply 10 suffers from the overvoltage, the protection sub-circuit 021 controls the external power supply signal to flow to the external appliance through the first power supply terminal V1, instead of flowing to the pixel driving circuit 01, such that the overvoltage occurs in the external equipment other than the display panel, thereby avoiding damaging the pixel driving circuit 01.

The protection sub-circuit 021 is further configured to: control the external power supply signal to output to the external power 10 in the case that the voltage of the external power supply signal (for example, −2V) is not within the range of the voltages required for the normal operation of the pixel driving circuit 01 and less than the voltage of the second power supply signal (for example, 0), that is, in the case that the external power supply signal 10 is undervoltage. That is, the external power supply signal is controlled to flow to the external power 10 instead of flowing to the pixel driving circuit 01, such that the undervoltage occurs in the external device other than the display panel, thereby avoiding damaging the pixel driving circuit 01.

The protection sub-circuit 021 is further configured to: control the external power supply signal to output to the pixel driving circuit 01 in the case that the voltage of the external power supply signal (e.g. 7.25V) is within the range of the voltages required for the normal operation of the pixel driving circuit 01, that is, the voltage of the external power supply is less than the voltage of the first power supply signal (e.g. 7.75V) and greater than the voltage of the second power supply signal (0), that is, in the case that the external power supply signal 10 is in the normal operation, thereby ensuring the normal operation of the pixel driving circuit 10.

On the basis that the voltages required for the normal operation of pixel driving circuit 01 are between 7.25V and 7.75V, the currents required for the normal operation of pixel driving circuit 01 can be between 0 and 10 mA.

The control sub-circuit 022 can be configured to transmit a switch control signal at a first potential to the control terminal of the switch sub-circuit 023 based on the first power supply signal, the second power supply signal, and the external power supply signal in the case that the current of the external power supply signal (such as 120 mA) is not within the range of the currents (such as 0 to 10 mA) required for the normal operation of the pixel driving circuit 01, that is, in the case that the external power 10 occurs the overcurrent. The switch sub-circuit 023 can be configured to control the external power supply 10 to be disconnected to the pixel driving circuit 01 based on the switch control signal at the first potential. In this case, the external power supply signal provided by the external power supply 10 cannot be transmitted to the pixel driving circuit 01, thereby realizing the overcurrent protection. The switch control signal at the first potential is the turn-off control signal described in the above embodiments.

Moreover, the control sub-circuit 022 can be configured to transmit a switch control signal at a second potential to the control terminal of the switch sub-circuit 023 based on the first power supply signal, the second power supply signal, and the external power supply signal in the case that the current of the external power supply signal (such as 1 mA) is within the range of the currents (such as 0 to 10 mA) required for the normal operation of the pixel driving circuit 01, that is, in the case that the external power supply 10 is in the normal operation. The switch sub-circuit 023 can be configured to control the external power supply 10 to be connected to the pixel driving circuit 01 based on the switch control signal of the second potential. In this case, the external power supply signal provided by the external power supply 10 can be transmitted to the pixel driving circuit 01 through the switch sub-circuit 023, thereby ensuring that the pixel driving circuit 10 works normally. The switch control signal at the second potential is the turn-on control signal described in the above embodiments.

In some embodiments, the first potential is an invalid potential, and the second potential is an effective potential. As described in the above embodiments, the first potential is a lower than the second potential.

FIG. 2 is a structural diagram of another display panel according to some embodiments of the present disclosure. As shown in FIG. 2, the protection sub-circuit 021 includes an overvoltage protection diode D1 and an undervoltage protection diode D2.

A positive electrode of the overvoltage protection diode D1 is coupled to the first electrode of the external power supply 10 (such as positive electrode +), and a negative electrode of the overvoltage protection diode D1 is coupled to the first power supply terminal V1.

A negative electrode of the undervoltage protection diode D2 is coupled to the second electrode of the external power supply 10 (such as negative electrode −), and both the negative electrode of the undervoltage protection diode D2 and the second electrode of the external power supply 10 are coupled to the second power supply terminal V2.

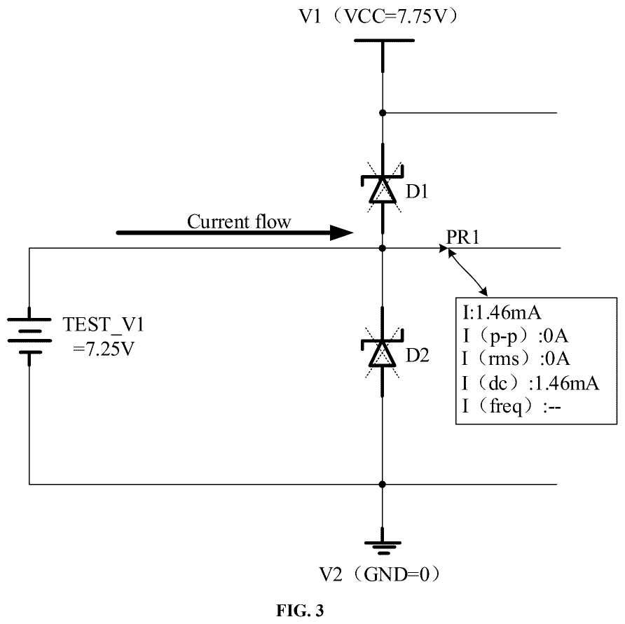

Taking the range of the voltages required for the normal operation of the pixel driving circuit 10 being 7.25V to 7.75V, and the currents required for the normal operation being 0 to 10 mA as an example, based on FIG. 2, FIGS. 3 to 5 respectively show the flow direction diagrams of three external power supply signals when the external power supply 10 is in the normal operation, the external power supply 10 occurs the undervoltage, and the external power supply 10 occurs the overvoltage. In addition, it should be noted that in FIGS. 3 to 5, the external power supply 10 is shown as a test signal terminal TEST_V1, the first power supply terminal V1 is shown as a VCC power supply terminal, the first power supply signal provided is 7.75V, the second power supply terminal V2 is shown as a GND, and the second power supply signal provided is 0.

For example, referring to FIG. 3, the voltage of the external power supply signal is 7.25V (that is, TEST_V1=7.25V), that is, the normal 7.25V is used for power supply. On this basis, based on the reverse cut-off characteristic of the diode, it can be seen that since 0<7.25V<7.75V, the overvoltage protection diode D1 and the undervoltage protection diode D2 are both turned off in the reverse direction (as the dotted line×shown in the figure, which is not described hereinafter). The current direction of the external power supply signal is as shown by the arrow in FIG. 3, without passing the overvoltage protection diode D1 and the undervoltage protection diode D2, Instead, the current flows to the pixel driving circuit 01. FIG. 3 further schematically shows a simulation result at a PR1 probe location, wherein a simulation current is 1.46 mA (<10 mA).

It should be noted that the reverse cut-off characteristic of the diode means that in the case that a positive voltage of the diode is less than a negative voltage of the diode, the diode is in a cutoff state, i.e., the diode is non-conductive.

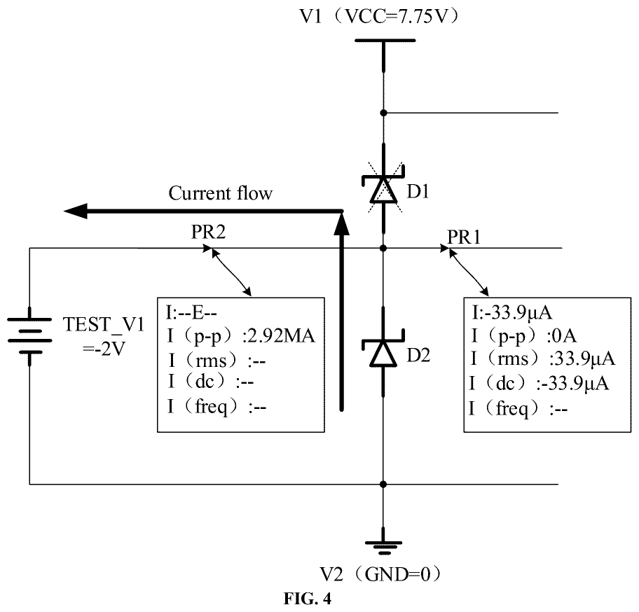

For example, referring to FIG. 4, the voltage of the external power supply signal is −2V (that is, TEST_V1=−2V), and the external power supply is in an undervoltage power supply state. On this basis, it can be seen that since −2V<0<7.75V, the overvoltage protection diode D1 is turned off in the reverse direction, and the undervoltage protection diode D2 is turned on in the forward direction. The current direction of the external power supply signal is as shown by the arrow in FIG. 4. Instead of passing through the overvoltage protection diode D1 or flowing to the pixel driving circuit 10, the current flows to the external power supply 10 through the second power supply terminal V2 (that is, the GND=0) and the undervoltage protection diode D2. The undervoltage protection is achieved. FIG. 4 further schematically shows the simulation result at the PR1 probe location, and a simulation result at a PR2 probe location. The current simulated at the PR1 probe location is −33.9 μA (<10 mA). Based on the simulation result at the PR2 probe location, it can be seen that the overcurrent caused by undervoltage can occur in the external equipment instead of the display panel.

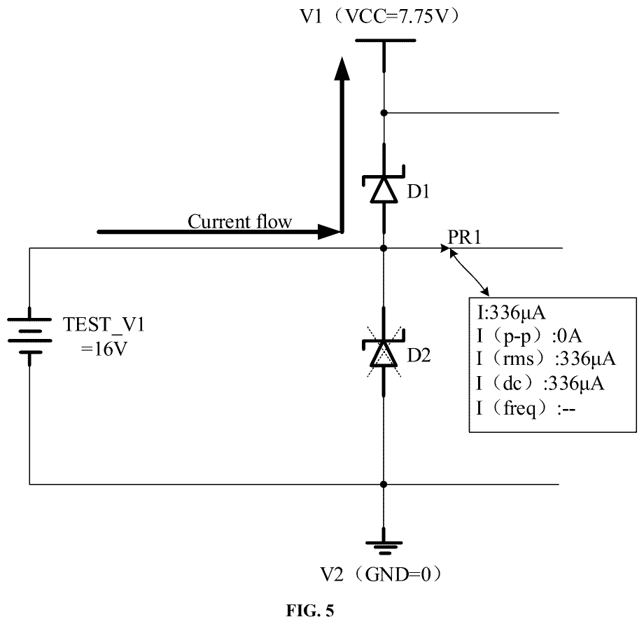

For example, referring to FIG. 5, the voltage of the external power supply signal is 16V (that is, TEST_V1=16V), and the external power supply is in an overvoltage power supply state. On this basis, it can be seen that since 0<7.75V<16V, the overvoltage protection diode D1 is connected in the forward direction, and the undervoltage protection diode D2 is cut-off in the reverse direction. The current direction of the external power supply signal is as shown by the arrow in FIG. 5. Instead of passing through the undervoltage protection diode D2 or flowing to the pixel driving circuit 10, the current flows to the first power supply terminal V1 through the overvoltage protection diode D1, such as flowing to the external appliance coupled to the first power supply terminal V1. The overvoltage protection is achieved. FIG. 5 also schematically shows a simulation result at the PR1 probe location, wherein the current simulated at the PR1 probe location is 336 μA (<10 mA).

FIG. 6 is a schematic diagram of a structure of yet another display panel according to some embodiments of the present disclosure. As shown in FIG. 6, the control sub-circuit 022 according to some embodiments of the present disclosure may include: a detecting unit 0221 and a primary feedback unit 0222.

In some embodiments, two terminals of the detecting unit 0221 are coupled to the first electrode of the external power supply 10 and the input terminal of the switch sub-circuit 023, i.e., the detecting unit 0221 is connected in series between the positive electrode of the external power supply 10 and the input terminal of the switch sub-circuit 023. The detecting unit 0221 is configured to detect the current of the external power supply signal.

The primary feedback unit 0222 is coupled to the two terminals of the detecting unit 0221, the first power supply terminal V1, the second power supply terminal V2, and the control terminal of the switch sub-circuit 023. The primary feedback unit 0222 is configured to generate the switch control signal based on the first power supply signal, the second power supply signal, and the current of the external power supply signal, and transmit the switch control signal to the control terminal of the switch sub-circuit 023.

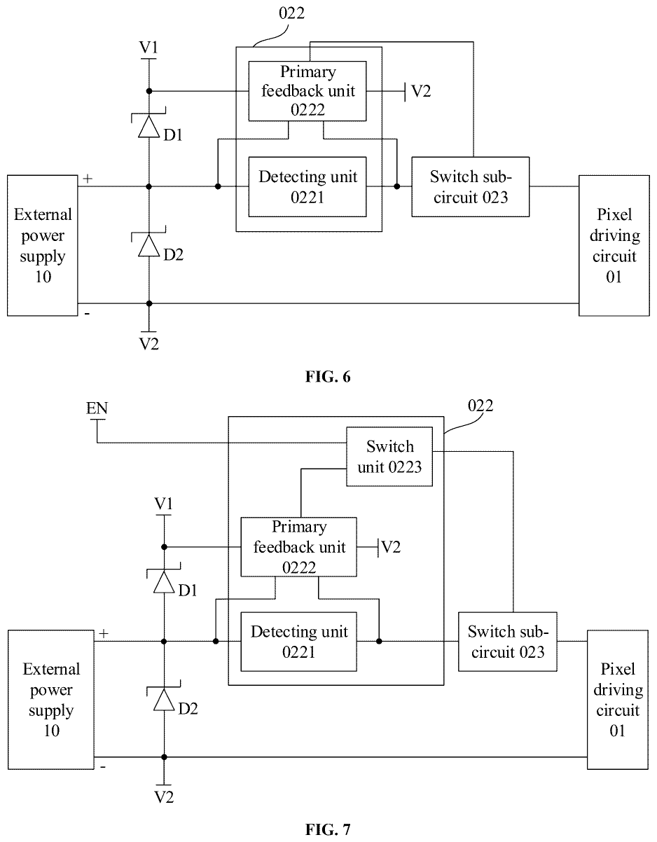

FIG. 7 is a schematic diagram of a structure of still another display panel according to some embodiments of the present disclosure. As shown in FIG. 7, the control sub-circuit 022 may further include: a switch unit 0223.

The switch unit 0223 is coupled to an enable power supply terminal EN, the primary feedback unit 0222, and the control terminal of the switch sub-circuit 023, that is, the switch unit 0223 is coupled between the primary feedback unit 0222 and the switch sub-circuit 023. The switch unit 0223 is configured to receive a switch signal, and control the control terminal of the switch sub-circuit 023 to be connected to the enable power supply terminal EN or control the control terminal of the control switch sub-circuit 023 to be connected to the primary feedback unit 0222 based on the switch signal. On this basis, the switch sub-circuit 023 can further be configured to control the external power supply 10 to be disconnected to the pixel driving circuit 01 based on the enable power supply signal provided by the enable power supply terminal EN.

For example, as described in the above embodiments, the enable power supply signal is also referred to as the turn-off control signal. In the case that the switch sub-circuit 023 includes a P-type transistor, a potential of the enable power supply signal is a high potential (e.g., 7V). It should be noted that the enable power terminal EN can further be coupled to the external appliances of non-display panel to receive the enable power supply signal. Because the enabling power supply terminal EN is coupled to the overcurrent control part, the enabling power supply terminal EN can also be referred to as an overcurrent protection enabling pin.

In some embodiments, the display panel further includes a switch control circuit, wherein the switch control circuit is coupled to the switch unit 0223 and configured to provide a switch signal to the switch unit 0223, which is not shown in FIG. 7. Taking an execution of the OTP action as an example, the switch control circuit can provide a switch signal to the switch unit 0223 prior to entering the OTP action, wherein the switch signal is configured to control the connection between the control terminal of the switch sub-circuit 023 and the enable power terminal EN, such that the switch sub-circuit 023 disconnects the coupling between the external power supply 10 and the pixel driving circuit 01. In addition, when the OTP action is entered, the switch control circuit provide a switch signal to the switch unit 0223, wherein the switch signal is configured to control the connection between the control terminal of the switch sub-circuit 023 and the primary feedback unit 0222, such that the switch sub-circuit 023 controls the connection/disconnection between the external power supply 10 and the pixel driving circuit 01 based on the switch control signal fed back by the primary feedback unit 0222. By setting the switch unit 0223, a secondary control of the switch sub-circuit 023 can be realized, which belongs to a secondary protection design.

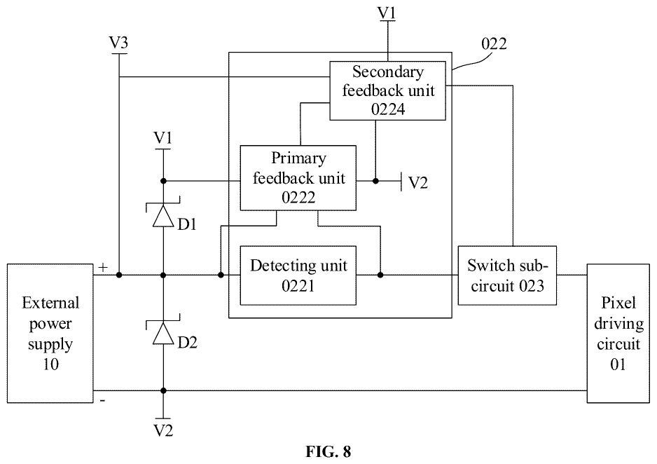

FIG. 8 is a schematic diagram of a structure of still another display panel according to some embodiments of the present disclosure. As shown in FIG. 8, in another embodiment, the control sub-circuit 022 may further include: a secondary feedback unit 0224.

The secondary feedback unit 0224 is coupled between the primary feedback unit 0222, the control terminal of the switch sub-circuit 023, the first power terminal V1, the second power terminal V2, and a third power terminal V3. The secondary feedback unit 0224 is configured to perform a buck process on the switch control signal generated by the primary feedback unit 0222 based on the external power supply signal, the first power supply signal, the second power supply signal, and a third power supply signal provided by the third power terminal V3, and transmit a switch control signal performed with the buck process to the control terminal of the switch sub-circuit 023. That is, the secondary feedback unit 0224 can redefine the switch control signal generated by the primary feedback unit 0222. By performing the buck process, the turn-on control signal can be transmitted to the switch sub-circuit 023 in time in the case that there is no overcurrent, such that the switch sub-circuit 023 can reliably connect the external power supply 10 and the pixel driving circuit 01, thereby improving the correctness of OTP action, which belongs to a design that indirectly controls the current threshold.

In some embodiments, the third power supply terminal V3 is coupled to the first electrode of the external power supply 10, that is, the third power supply signal is the external power supply signal, thereby simplifying the design of the power supply terminal and saving costs.

In some embodiments, based on FIG. 8 and referring to a display panel shown in FIG. 9, the secondary feedback unit 0224 may include: a threshold setting subunit 02241 and a threshold control subunit 02242.

The threshold setting subunit 02241 is coupled to the second power terminal V2, the third power terminal V3, and the threshold control subunit 02242. The threshold setting subunit 02241 is configured to transmit a reference power supply signal to the threshold control subunit 02242 based on the second power supply signal and the external power supply signal, wherein a potential of the reference power supply signal can be greater than a potential of the switch control signal.

The threshold control subunit 02242 is further coupled to the first power supply terminal V1, the second power supply terminal V2, the primary feedback unit 0222, and the control terminal of the switch sub-circuit 023. The threshold control subunit 02242 is configured to perform the buck process on the switch control signal generated by the primary feedback unit 0222 based on the first power supply signal, the second power supply signal and the reference power supply signal, and transmit the switch control signal performed with the buck process to the control terminal of the switch sub-circuit 023.

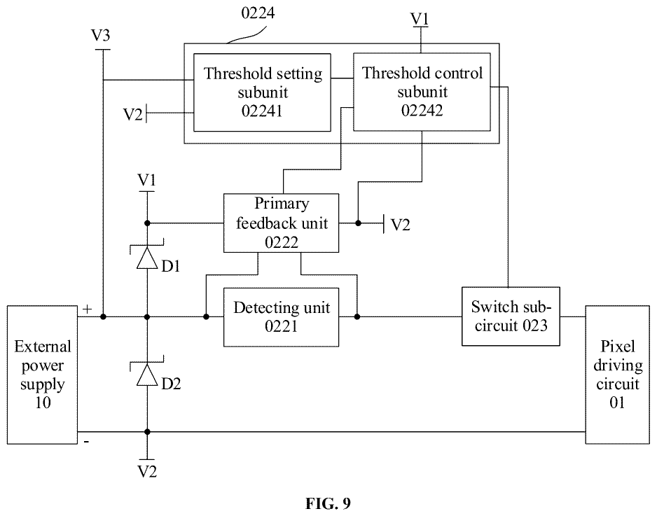

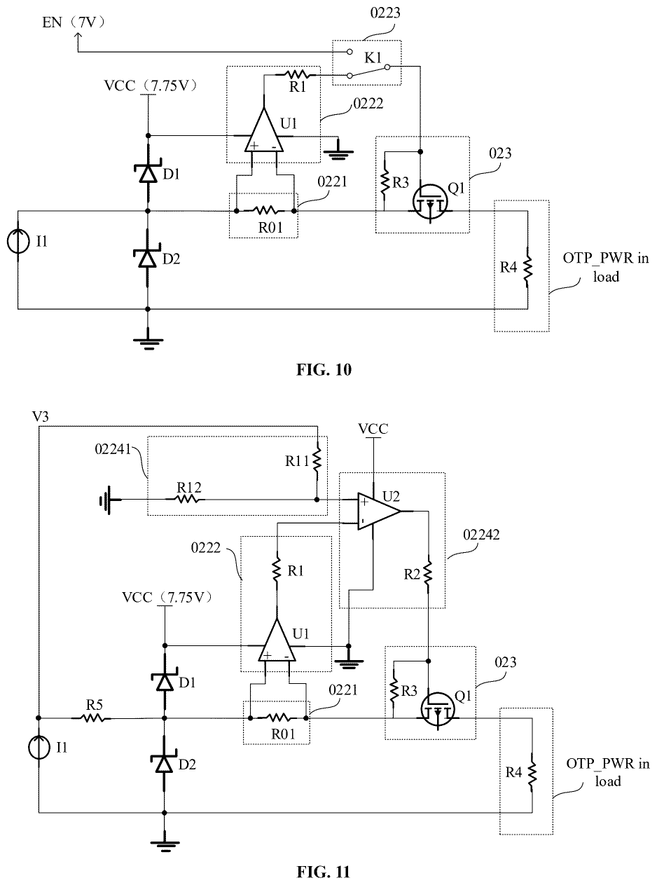

In some embodiments, taking the structure shown in FIG. 7 as an example, FIG. 10 illustrates a schematic diagram of a structure of still another display panel. Taking the structure shown in FIG. 9 as an example, FIG. 11 illustrates a schematic diagram of a structure of still another display panel.

Referring to FIGS. 10 and 11, it can be seen that the detecting unit 0221 can include a sampling resistor R01.

A first end of the sampling resistor R01 is coupled to the first electrode of the external power supply 10, and a second end of the sampling resistor R01 is coupled to the input terminal of the switch sub-circuit 023. That is, in combination with the embodiments described above, the sampling resistor R01 is set to measure the current flowing on the first connection line, that is, the current of the external power supply signal. The voltage difference between the two terminals of the sampling resistor R01 indicates the current.

In some embodiments, the resistance value of the sampling resistor R01 is small, thereby ensuring a reliable current detection. For example, the resistance value of the sampling resistor R01 shown in the figure is 0.02 ohm (Ω).

Continuing to refer to FIGS. 10 and 11, the primary feedback unit 0222 can include: a first differential amplifier U1 and the first resistor R1. For example, the resistance value of the first resistor R1 is 100Ω.

A positive input terminal (+) and a negative input terminal (−) of the first differential amplifier U1 can be respectively coupled to the two terminals of the detecting unit 0221, that is, as shown in FIG. 10, on the basis that the detecting unit 0221 is the sampling resistor R01, the positive input terminal (+) and the negative input terminal (−) of the first differential amplifier U1 can be respectively coupled to the first end and the second end of the sampling resistor R01. A power supply terminal of the first differential amplifier U1 can be coupled to the first power supply terminal V1 and the second power supply terminal V2, an output terminal of the first differential amplifier U1 can be coupled to the first end of the first resistor R1, and the second end of the first resistor R1 can be coupled to the control terminal of the switch sub-circuit 023. Because the structure shown in FIG. 7 also includes the switch unit 0223, FIGS. 10 and 11 do not show that the second end of the first resistor R1 can be coupled to the control terminal of the switch sub-circuit 023. On this basis, it can be seen that the first differential amplifier U1 can generate the switch control signal by amplifying, based on the first power supply signal and the second power supply signal, a voltage difference between the two ends of the sampling resistor R01.

Continuing to refer to FIG. 10, it can be seen that in some embodiments shown in FIG. 7, the switch unit 0223 may include: a single pole double throw switch K1.

A stationary contact of the single pole double throw switch K1 can be coupled to the control terminal of the switch sub-circuit 023, and two movable contacts of the single pole double throw switch K1 can respectively be coupled to the primary feedback unit 0222 and the enable power supply terminal EN. Herein, the movable contact can be considered as being coupled to the second end of the first resistor R1 in the primary feedback unit 0222.

In some other embodiments, the switch unit 0223 is a switch transistor. For example, the switch unit 0223 is a P-metal-oxide-semiconductor (PMOS) field effect transistor, i.e., PMOS transistor, or the switch unit 0223 is an N-metal-oxide-semiconductor (NMOS) transistor. The structure of the switch unit 0223 is not limited in the embodiments of the present disclosure.

Referring to FIG. 11, in some other embodiments of FIG. 9, the threshold setting subunit 02241 may include: a plurality of divided resistors coupled to each other, wherein at least one of the plurality of divided resistors is a variable resistor.

The plurality of divided resistors can further be coupled to the threshold control subunit 02242, and one part of the plurality of divided resistors can be coupled to the second power supply terminal V2, and the other part of the plurality of divided resistors can be coupled to the third power supply terminal V3. For example, in the case that the third power supply terminal V3 is coupled to the first electrode of the external power supply 10, the other part of the plurality of divided resistors are considered to be coupled to the first electrode of the external power supply 10. The plurality of divided resistors can be configured to generate a reference power supply signal by performing, based on the third power supply signal and the second power supply signal, a voltage dividing process, wherein the potential of the reference power supply signal is greater than the potential of the switch control signal. Accordingly, by setting at least one of the divided resistors as a variable resistor, a divider capability can be flexibly adjusted. Before the product is released, the resistor value of each of the plurality of divided resistors can be flexibly designed based on the external power supply signal provided by the external power supply 10 and the power supply signal required by the pixel driving circuit 01, thereby ensuring a reliable redefinition of the switch control signal.

In some embodiments, the threshold setting subunit 02241 shown in FIG. 11 includes two divided resistors: a first divided resistor R11 and a second divided resistor R12, wherein the second divided resistor R12 is the variable resistor. Resistance values of the first divided resistor R11 and the second divided resistor R12 are both 2 kiloohms (KΩ).

A first end of the first divided resistor R11 can be coupled to the third power supply terminal V3 (such as the positive electrode of the external power supply 10), and a second end of the first divided resistor R11 can be coupled to the threshold control subunit 02242.

A first end of the second divided resistor R12 can be coupled to the second power supply terminal V2, and a second end of the second divided resistor R12 can be coupled to the threshold control subunit 02242.

The second end of the first divided resistor R11 can be coupled to the second end of the first divided resistor R11.

Continuing to refer to FIG. 11, the threshold control subunit 02242 may include: a second differential amplifier U2 and a second resistor R2. For example, a resistance value of the second resistor R2 is 100Ω.

A positive input terminal (+) of the second differential amplifier U2 can be coupled to the threshold setting subunit 02241, a negative input terminal (−) of the second differential amplifier U2 can be coupled to the primary feedback unit 0222, a power terminal of the second differential amplifier U2 can be coupled to the first power supply terminal V1 and the second power supply terminal V2, an output terminal of the second differential amplifier U2 can be coupled to a first end of the second resistor R2, and a second end of the second resistor R2 can be coupled to the control terminal of the switch sub-circuit 023.

In some embodiments, according to the embodiments described above, the positive input terminal (+) of the second differential amplifier U2 can be coupled to the second end of the first divided resistor R11 and the second end of the second divided resistor R12, and the negative input terminal (−) of the second differential amplifier U2 can be coupled to the second end of the first resistor R1 included in the primary feedback unit 0222. On this basis, the second differential amplifier U2 can redefine the switch control signal by amplifying, based on the first power supply signal and the second power supply signal, a voltage difference between the reference power supply signal and the switch control signal.

Further referring to FIGS. 10 and 11, the switch sub-circuit 023 may include: a switch transistor Q1 and a third resistor R3.

A gate of the switch transistor Q1 can be coupled to the control sub-circuit 022 as the control terminal of the switch sub-circuit 023, a first electrode of the switch transistor Q1 can be coupled to the first electrode of the external power supply 10 through the control sub-circuit 022 as the input terminal of the switch sub-circuit 023, and a second electrode of the switch transistor Q1 can be coupled to the pixel driving circuit 01 as the output terminal of the switch sub-circuit 023.

A first end of the third resistor R3 can be coupled to the gate of the switch transistor Q1, and a second end of the third resistor R3 can be coupled to the first electrode of the switch transistor Q1.

In some embodiments, with respect to the structure corresponding to the embodiment of FIG. 10, the gate of the switch transistor Q1 can be coupled to the stationary contact of the single pole double throw switch K1 included in the switch unit 0223 in the control sub-circuit 022. With respect the structure corresponding to another embodiment of FIG. 11, the gate of the switch transistor Q1 can be coupled to the second end of the second resistor R2 included in the threshold control subunit 02242 in the control sub-circuit 022. In FIGS. 10 and 11, the first electrode of the switch transistor Q1 is coupled to the second end of the sampling resistor R01 in the control sub-circuit 022.

In some embodiments of the present disclosure, the switch transistor Q1 is conductive in response to the switch control signal at the first potential, such that the external power supply 10 is connected to the pixel driving circuit 01. The switch transistor Q1 is non-conductive in response to the switch control signal at the second potential, such that the external power supply 10 is disconnected to the pixel driving circuit 01.

By setting the third resistor R3, the switch transistor Q1 can be ensured to be reliably cut off before the external power supply 10 is connected, such as before the OTP action is performed, and the single pole double throw switch K1 included in the switch unit 0223 is coupled to the enable power supply terminal EN but no power supply, thereby avoiding damage caused by static electricity (which may be generated by friction during transportation). The resistance value of the third resistor R3 can be set to a larger value, such as 1 megohm (MΩ).

In some embodiments, the switch transistor Q1 is a PMOS transistor. Accordingly, based on the operating characteristics of the PMOS transistor, the first potential of the switch control signal (i.e., the potential of the turn-off control signal) is a high potential, and the second potential of the switch control signal (i.e., the potential of the turn-on control signal) is a low potential. In some other embodiments, the switch transistor Q1 is an NMOS transistor. Accordingly, based on the operating characteristics of the NMOS transistor, the first potential of the switch control signal (i.e., the potential of the turn-off control signal) is a low potential, and the second potential of the switch control signal (i.e., the potential of the turn-on control signal) is a high potential. The embodiments of the present disclosure take the switch transistor Q1 being the PMOS transistor as an example. In addition, one of the first and second electrodes of the switch transistor Q1 can be a source electrode and the other can be a drain electrode.

It should be noted that in FIGS. 10 and 11, the first power supply terminal V1 are the VCC power supply terminal, and the first power supply signal provided is 7.75V. The second power supply terminal V2 is the GND, and the second power supply signal provided by the second power supply terminal V2 is 0. The potential of the enable power supply signal provided by the enable power terminal EN shown in FIG. 10 is 7V. The third power supply terminal V3 shown in FIG. 11 is coupled to the positive electrode of the external power supply 10.

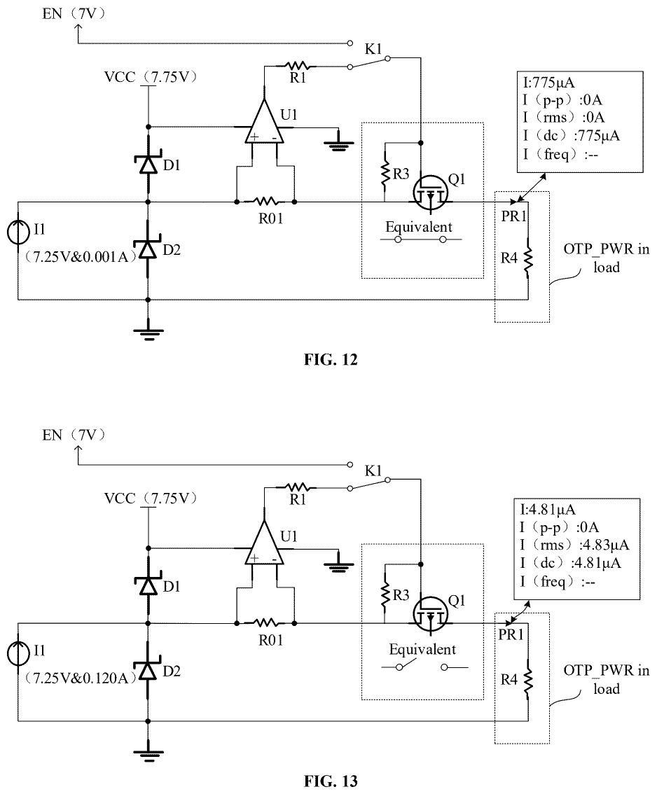

Taking the range of the voltages required for the normal operation of the pixel driving circuit 10 being 7.25V to 7.75V, and the currents required for the normal operation being 0 to 10 mA as an example, based on FIG. 10, FIGS. 12 and 13 show two simulation diagrams respectively when the external power supply 10 is operating normally and when the external power supply 10 occurs the overcurrent. It should be noted that a constant current source I1 is configured to simulate the external power supply 10 in FIGS. 10 to 13.

For example, referring to FIG. 12, the voltage of the external power supply signal is 7.25V, and the current of the external power supply signal is 1 mA (0.01 A), that is, the normal 7.25V & 1 mA external power supply signal is configured for power supply. On this basis, after the current passes through the sampling resistor R01, the voltage difference can be sampled and fed back through the first differential amplifier U1. And the first differential amplifier U1 generates the switch control signal at the second potential (that is, the turn-on control signal) and transmits the switch control signal at the second potential to the gate of the switch transistor Q1, such that the switch transistor Q1 is turned on. The path between the external power supply 10 and the pixel driving circuit 01 is equivalent to the path shown in FIG. 12. The 1 mA current can enter through the first electrode of the switch transistor Q1 (such as the source electrode), and output to the pixel driving circuit 01 through the second electrode of the switch transistor Q1 (such as the drain electrode). When applied to OTP action, normal burning is completed. FIG. 12 further schematically shows a simulation result at the PR1 probe location, wherein a simulation current is 775 μA.

For example, refer to FIG. 13, the voltage of the external power supply signal is 7.25V, and the current of the external power supply signal is 120 mA (0.120 A), that is, an abnormal 7.25V & 120 mA external power supply signal is configured for power supply. On this basis, after the current passes through the sampling resistor R01, a voltage difference can be sampled and fed back through the first differential amplifier U1. And the first differential amplifier U1 generates the switch control signal at the first potential (that is, the turn-off control signal) and transmits the switch control signal at the first potential to the gate of the switch transistor Q1, such that the switch transistor Q1 is turned off. The path between the external power supply 10 and the pixel driving circuit 01 is equivalent to the open circuit shown in FIG. 13. The 120 mA excessive current cannot enter through the first electrode of the switch transistor Q1 (such as the source electrode), and thus cannot output to the pixel driving circuit 01 through the second electrode of the switch transistor Q1 (such as the drain electrode), that is, the excessive current cannot enter the interior of the pixel driving circuit 01, such that the overcurrent protection is achieved. FIG. 13 further schematically shows a simulation result at the PR1 probe location, wherein a simulation current is 4.81 μA.

In some embodiments, as described in the above embodiment, the pixel driving circuit 01 includes an OTP module. The protection circuit 02 is coupled to the OTP module, and the protection circuit 02 is configured to transmit the received external power supply signal to the OTP module. The protection circuit 02 provided by the embodiments of the present disclosure can avoid burning out the internal structure of the OTP module due to the abnormal external power supply signal provided by the external power supply 10 during the OTP action, thereby achieving reliable protection of the OTP module.

For example, referring to FIGS. 10 to 13, a fourth resistor R4 represents a load in the pixel driving circuit 01, such as a load in the OTP module in the pixel driving circuit 01, which is identified as an OTP_PWR in.

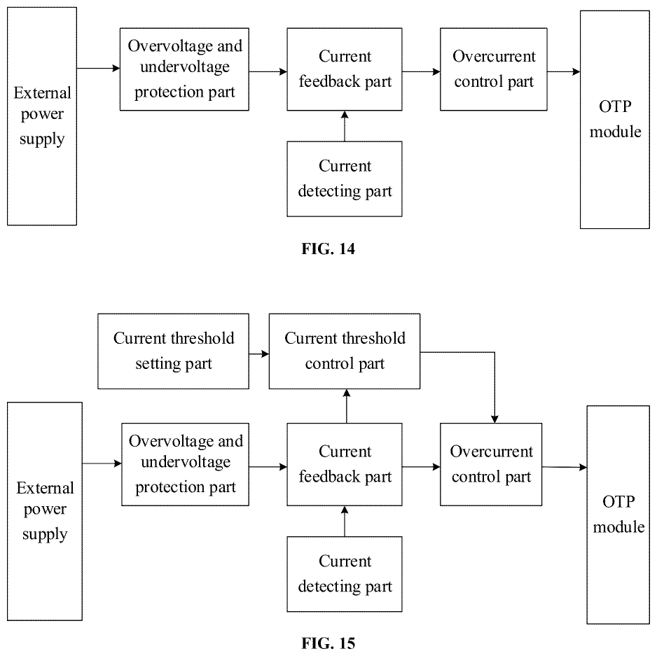

In some embodiments, based on the above embodiments, FIG. 14 further illustrates a block diagram of a circuit diagram as an example. FIG. 15 illustrates a block diagram of a circuit diagram as an example of FIG. 11.

With reference to FIGS. 14 and 15, it can be seen that the pixel circuit in the display panel described in the embodiments of the present disclosure can include: an overvoltage and undervoltage protection part (i.e., the protection sub-circuit 021), a current detecting part (i.e., the detecting unit 0221 in the control sub-circuit 022), a current feedback part (i.e., the primary feedback unit 0222 in the control sub-circuit 022), and an overcurrent control part (i.e. the switch sub-circuit 023). In addition, in the display panel shown in FIG. 15, a current threshold setting part (i.e., the threshold setting subunit 02241) and a current threshold control part (i.e., the threshold control subunit 02242) are included.

The overvoltage and undervoltage protection part can be coupled to the external power supply 10 (also referred to as a power supply equipment) and the current feedback part. The current detecting part can be coupled to the current feedback part. The current feedback part can be coupled to the overcurrent control part, and in the case that the current threshold control part is included, the current feedback part can further be coupled to the current threshold control part. The current threshold setting part can be coupled to the current threshold control part and the overcurrent control part. The overcurrent control part can be coupled to the pixel driving circuit 01, as the OTP module shown in FIGS. 14 and 15. The specific structure and working principle of each of the parts can refer to the embodiment described above, and is not repeated herein.

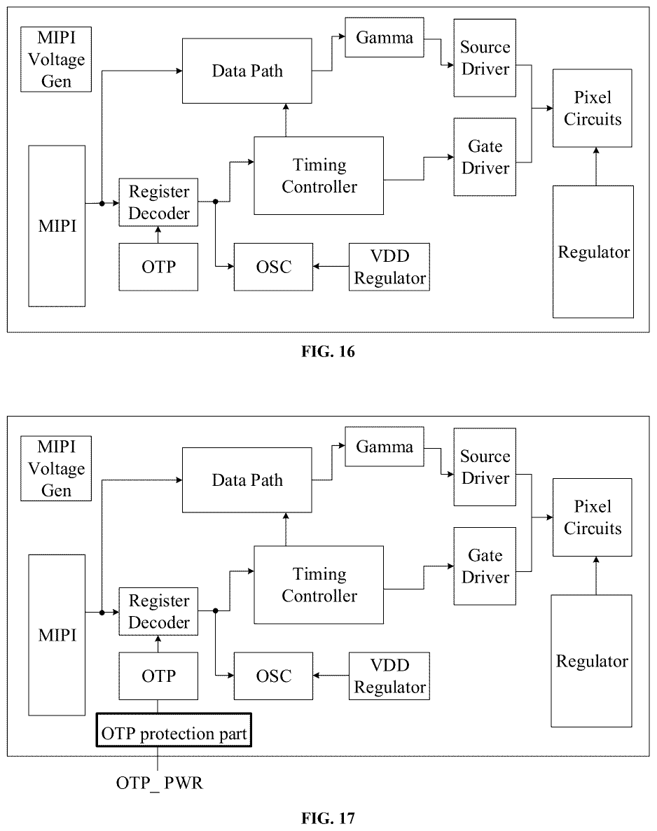

In some embodiments, taking the OTP module being included as an example, FIG. 16 shows an overall structural block diagram of the circuit in the display panel in a related technology. FIG. 17 shows an overall structural block diagram of the circuit in the display panel according to some embodiments of the present disclosure. Referring to FIGS. 16 and 17, it can be seen that compared with the related technology, the OTP module in the embodiments of the present disclosure can be indirectly coupled to the external power supply (identified as OTP_PWR) through an OTP protection unit (that is, the protection circuit 02 described in the above embodiments), thereby realizing the protection of the OTP module.

In addition, FIGS. 16 and 17 further show other structures in some circuits, such as a power management circuit (MIPI), a voltage load of the power management circuit (MIPI Voltage Gen), a data path, a register decoder, a timing controller, a gamma circuit, a source driver, a gate driver, an oscillator (OSC), a power regulator (VDD Regulator) and a regulator, and a pixel driving circuit. Coupling relationships can refer to the accompanying drawings, and are not described in detail herein.

In the case that the display panel is the silicon-based OLED display panel, the circuit composed of the parts shown in FIGS. 16 and 17 can be referred to as the silicon-based IC, and the OTP module belongs to a part of the silicon-based IC. On the basis that protecting the OTP module through the protection circuit 02, the protection of the silicon-based IC can be realized to avoid damage to the silicon-based IC.

In summary, the embodiments of the present disclosure provide the display panel. The display panel includes the pixel driving circuit and the protection circuit, wherein the protection circuit indirectly couples the pixel driving circuit to an external power supply. The protection circuit includes the protection sub-circuit, the control sub-circuit, and the switch sub-circuit. The protection sub-circuit controls the flow direction of the external power supply signal provided by the external power supply based on the first power supply signal and the second power supply signal. In this way, by flexibly setting the first power supply signal and the second power supply signal, the external power supply signal flows to the pixel driving circuit only when there is no overvoltage or undervoltage, thereby realizing the overvoltage protection and the undervoltage protection for the pixel driving circuit. The control sub-circuit enables the switch sub-circuit to control the connection/disconnection between the external power supply and the pixel driving circuit by transmitting, based on the first power supply signal, the second power supply signal, and the external power supply signal, the switch control signal to the switch sub-circuit. In this way, by flexibly setting the first power supply signal and the second power supply signal, the external power supply is controlled to be connected to the pixel driving circuit only when there is no overcurrent, and the external power supply signal is transmitted to the pixel driving circuit, such that the overcurrent protection of the pixel driving circuit is realized. The pixel driving circuit is prevented from being damaged.

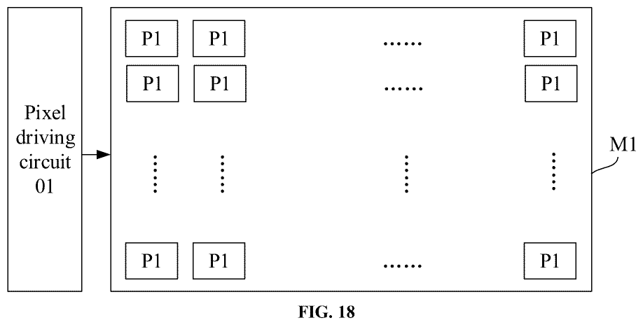

FIG. 18 is a structural diagram of a display device according to some embodiments of the present disclosure. As shown in FIG. 18, the display device includes a display panel M1 described in the above embodiments and a plurality of pixels P1 on the display panel M1. The pixel driving circuit 01 in the display panel M1 can be coupled to the plurality of pixels P1, and the pixel driving circuit 01 is configured to drive the plurality of pixels P1 to emit light, such that the display panel M1 can display a picture.

In some embodiments, as described in the above embodiments, the display device is a silicon-based OLED display apparatus. Accordingly, the pixel P1 is a silicon-based OLED.

In some embodiments, the display device described in the embodiments of the present disclosure is: a cell phone, a tablet computer, a flexible display device, a television, a monitor, or any other product or component having a display function.

The terms used in the embodiments of the present disclosure are only used to explain the embodiments of the present disclosure and not intended to limit thereto. Unless otherwise defined, technical or scientific terms used in the embodiments of the present disclosure should have the ordinary meaning understood by a person of ordinary skill in the art to which the present disclosure pertains.

For example, in the embodiments of the present disclosure, the terms “first” and “second” are used for descriptive purposes only and not indicate or imply relative importance. The term “plurality of” refers to two or more, unless otherwise defined.

Similarly, the terms such as “one” or “a” do not indicate a quantitative limitation, but indicates the existence of at least one.

The terms “includes” or “contains” are intended to indicate that the elements or objects appearing before “includes” or “includes” cover the elements, the objects, and their equivalents appearing after “includes” or “includes”, and do not exclude other elements or objects.

The terms “up,” “down,” “left” or “right” are only used to indicate relative positional relationships. In the case that an absolute position of the object is changed, the relative positional relationship may be changed accordingly.

The term “and/or” herein is merely a description of an association relationship between associated objects, indicating that there are three possible relationships. For example, the phrase “A and/or B” means (A), (B), or (A and B). The symbol “/” herein generally indicates an “or” relationship between the associated objects.

Described above are merely optional embodiments of the present disclosure, but are not intended to limit the present disclosure. Any modifications, equivalent replacements, improvements and the like made within the spirit and principle of the present disclosure shall be included within the protection scope of the present disclosure.

1. A display panel, comprising:
a pixel driving circuit and a protection circuit, wherein the protection circuit is coupled to the pixel driving circuit and an external power supply, and the protection circuit is configured to receive an external power supply signal provided by the external power supply and transmit the external power supply signal to the pixel driving circuit, wherein the external power supply includes a first electrode and a second electrode; and the protection circuit includes: a protection sub-circuit, a control sub-circuit, and a switch sub-circuit;
the protection sub-circuit is coupled to a first power supply terminal, a second power supply terminal, and the first electrode and the second electrode of the external power supply, the second electrode of the external power supply is further coupled to the second power supply terminal, and the protection sub-circuit is configured to control a flow direction of the external power supply signal based on a first power supply signal provided by the first power supply terminal, a second power supply signal provided by the second power supply terminal, and the external power supply signal;
the control sub-circuit is coupled to the first power supply terminal, the second power supply terminal, a control terminal of the switch sub-circuit, and the first electrode of the external power supply; and the control sub-circuit is configured to transmit a switch control signal to the control terminal of the switch sub-circuit based on the first power supply signal, the second power supply signal, and the external power supply signal; and
an input terminal of the switch sub-circuit is coupled to the first electrode of the external power supply through the control sub-circuit, an output terminal of the switch sub-circuit is coupled to the pixel driving circuit, and the switch sub-circuit is configured to control connection/disconnection between the external power supply and the pixel driving circuit based on the switch control signal.

2. The display panel according to claim 1, wherein a voltage of the first power supply signal is greater than a voltage of the second power supply signal, the voltage of the first power supply signal is not less than an upper limit value of a voltage required for normal operation of the pixel driving circuit, and the voltage of the first power supply signal is not greater than a lower limit value of the voltage required for the normal operation of the pixel driving circuit;
the protection sub-circuit is configured to: control the external power supply signal to be output to the pixel driving circuit in a case that a voltage of the external power supply signal is within a range of the voltages required for the normal operation; control the external power supply signal to be output from the first power supply terminal in a case that the voltage of the external power supply signal is not within the range of the voltages required for the normal operation and greater than the voltage of the first power supply signal; and control the external power supply signal to be output to the external power supply in a case that the voltage of the external power supply signal is not within the range of the voltages required for the normal operation and less than the voltage of the second power supply signal;
the control sub-circuit is configured to: transmit a switch control signal at a first potential to the control terminal of the switch sub-circuit based on the first power supply signal, the second power supply signal, and the external power supply signal in a case that a current of the external power supply signal is not within a range of currents required for the normal operation of the pixel driving circuit; and transmit a switch control signal at a second potential to the control terminal of the switch sub-circuit based on the first power supply signal, the second power supply signal, and the external power supply signal in a case that the current of the external power supply signal is within the range of the currents required for the normal operation of the pixel driving circuit; and
the switch sub-circuit is configured to: control the external power supply to be disconnected to the pixel driving circuit based on the switch control signal at the first potential, and control the external power supply to be connected to the pixel driving circuit based on the switch control signal at the second potential.

3. The display panel according to claim 1, wherein the protection sub-circuit comprises: an overvoltage protection diode and an undervoltage protection diode;
wherein a positive electrode of the overvoltage protection diode is coupled to the first electrode of the external power supply, and a negative electrode of the overvoltage protection diode is coupled to the first power supply terminal; and
a positive electrode of the undervoltage protection diode is coupled to the second electrode of the external power supply, and both the positive electrode of the undervoltage protection diode and the second electrode of the external power supply are coupled to the second power supply terminal.

4. The display panel according to claim 1, wherein the control sub-circuit comprises: a detecting unit and a primary feedback unit;
wherein two terminals of the detecting unit are respectively coupled to the first electrode of the external power supply and the input terminal of the switch sub-circuit, and the detecting unit is configured to detect a current of the external power supply signal; and
the primary feedback unit is coupled to the two terminals of the detecting unit, the first power supply terminal, the second power supply terminal, and a control terminal of the switch sub-circuit, and the primary feedback unit is configured to generate a switch control signal based on the first power supply signal, the second power supply signal, and the current of the external power supply signal, and transmit the switch control signal to the control terminal of the switch sub-circuit.

5. The display panel according to claim 4, wherein the detecting unit comprises: a sampling resistor;
wherein a first end of the sampling resistor is coupled to the first electrode of the external power supply, and a second end of the sampling resistor is coupled to the input terminal of the switch sub-circuit.

6. The display panel according to claim 4, wherein the primary feedback unit comprises: a first differential amplifier and a first resistor;
wherein a positive input terminal and a negative input terminal of the first differential amplifier are coupled to the two terminals of the detecting unit, a power supply terminal of the first differential amplifier is coupled to the first power supply terminal and the second power supply terminal, an output terminal of the first differential amplifier is coupled to a first end of the first resistor, and a second end of the first resistor is coupled to the control terminal of the switch sub-circuit.

7. The display panel according to claim 4, wherein the control sub-circuit further comprises: a switch unit;
wherein the switch unit is coupled to an enabling power supply terminal, the primary feedback unit and the control terminal of the switch sub-circuit, the switch unit is configured to receive a switch signal, and control the control terminal of the switch sub-circuit to be connected to the enabling power supply terminal or control the control terminal of the switch sub-circuit to be connected to the primary feedback unit based on the switch signal, and the switch sub-circuit is further configured to control the external power supply to be disconnected to the pixel driving circuit based on an enabling power supply signal provided by the enabling power supply terminal.

8. The display panel according to claim 7, wherein the switch unit comprises: a single pole double throw switch;
wherein a stationary contact of the single pole double throw switch is coupled to the control terminal of the switch sub-circuit, and two movable contacts of the single pole double throw switch are respectively coupled to the primary feedback unit and the enabling power terminal.

9. The display panel according to claim 4, wherein the control sub-circuit further comprises: a secondary feedback unit;
wherein the secondary feedback unit is coupled between the primary feedback unit and the control terminal of the switch sub-circuit, the secondary feedback unit is further coupled to the first power supply terminal, the second power supply terminal and a third power supply terminal, and the secondary feedback unit is configured to perform buck process on the switch control signal generated by the primary feedback unit based on the external power supply signal, the first power supply signal, the second power supply signal and a third power supply signal provided by the third power supply terminal, and transmit a switch control signal performed with the buck process to the control terminal of the switch sub-circuit.

10. The display panel according to claim 9, wherein the secondary feedback unit comprises: a threshold setting subunit and a threshold control subunit;
wherein the threshold setting subunit is coupled to the second power supply terminal, the third power supply terminal and the threshold control subunit, the threshold setting subunit is configured to transmit a reference power supply signal to the threshold control subunit based on the second power supply signal and the external power supply signal, wherein a potential of the reference power supply signal is greater than a potential of the switch control signal; and
the threshold control subunit is further coupled to the first power supply terminal, the second power supply terminal, the primary feedback unit and the control terminal of the switch sub-circuit, and the threshold control subunit is configured to perform the buck process on the switch control signal generated by the primary feedback unit based on the first power supply signal, the second power supply signal, and the reference power supply signal, and transmit the switch control signal performed with the buck process to the control terminal of the switch sub-circuit.

11. The display panel according to claim 10, wherein the threshold setting subunit comprises: a plurality of divided resistors coupled to each other;
wherein at least one of the plurality of divided resistors is a variable resistor, the plurality of divided resistors are coupled to the threshold control subunit, one part of the plurality of divided resistors are coupled to the second power supply terminal, and the other part of the plurality of divided resistors are coupled to the third power supply terminal.

12. The display panel according to claim 11, wherein the threshold setting subunit comprises: a first divided resistor and a second divided resistor, wherein the second divided resistor is a variable resistor;
wherein a first end of the first divided resistor is coupled to the third power supply terminal, a second end of the first divided resistor is coupled to the threshold control subunit, the third power supply terminal is further coupled to the first electrode of the external power supply, and the third power supply signal is the external power supply signal;
a first end of the second divided resistor is coupled to the second power supply terminal, and a second end of the second divided resistor is coupled to the threshold control subunit; and
the second end of the first divided resistor is coupled to the second end of the first divided resistor.

13. The display panel according to claim 10, wherein the threshold control subunit comprises: a second differential amplifier and a second resistor;
wherein a positive input terminal of the second differential amplifier is coupled to the threshold setting subunit, a negative input terminal of the second differential amplifier is coupled to the primary feedback unit, a power supply terminal of the second differential amplifier is coupled to the first power supply terminal and the second power supply terminal, an output terminal of the second differential amplifier is coupled to a first end of the second resistor, and a second end of the second resistor is coupled to the control terminal of the switch sub-circuit.

14. The display panel according to claim 1, wherein the switch sub-circuit comprises: a switch transistor and a third resistor;
wherein a gate of the switch transistor is coupled to the control sub-circuit as the control terminal of the switch sub-circuit, a first electrode of the switch transistor is coupled to the first electrode of the external power supply through the control sub-circuit as the input terminal of the switch sub-circuit, and a second electrode of the switch transistor is coupled to the pixel driving circuit as the output terminal of the switch sub-circuit; and
a first end of the third resistor is coupled to the gate of the switch transistor, and a second end of the third resistor is coupled to the first electrode of the switch transistor.

15. The display panel according to claim 1, wherein the pixel driving circuit comprises: a one-time program module;
wherein the protection circuit is coupled to the one-time program module, and the protection circuit is configured to transmit the external power supply signal to the one-time program module.

16. A display apparatus, comprising: a display panel, and a plurality of pixels disposed on the display panel, wherein the pixel driving circuit in the display panel is coupled to the plurality of pixels, and the pixel driving circuit is configured to drive the plurality of pixels to emit light, the display panel comprises:
a pixel driving circuit and a protection circuit, wherein the protection circuit is coupled to the pixel driving circuit and an external power supply, and the protection circuit is configured to receive an external power supply signal provided by the external power supply and transmit the external power supply signal to the pixel driving circuit, wherein the external power supply includes a first electrode and a second electrode; and the protection circuit includes: a protection sub-circuit, a control sub-circuit, and a switch sub-circuit;
the protection sub-circuit is coupled to a first power supply terminal, a second power supply terminal, and the first electrode and the second electrode of the external power supply, the second electrode of the external power supply is further coupled to the second power supply terminal, and the protection sub-circuit is configured to control a flow direction of the external power supply signal based on a first power supply signal provided by the first power supply terminal, a second power supply signal provided by the second power supply terminal, and the external power supply signal;
the control sub-circuit is coupled to the first power supply terminal, the second power supply terminal, a control terminal of the switch sub-circuit, and the first electrode of the external power supply; and the control sub-circuit is configured to transmit a switch control signal to the control terminal of the switch sub-circuit based on the first power supply signal, the second power supply signal, and the external power supply signal; and
an input terminal of the switch sub-circuit is coupled to the first electrode of the external power supply through the control sub-circuit, an output terminal of the switch sub-circuit is coupled to the pixel driving circuit, and the switch sub-circuit is configured to control connection/disconnection between the external power supply and the pixel driving circuit based on the switch control signal.

17. The display apparatus according to claim 16, wherein a voltage of the first power supply signal is greater than a voltage of the second power supply signal, the voltage of the first power supply signal is not less than an upper limit value of a voltage required for normal operation of the pixel driving circuit, and the voltage of the first power supply signal is not greater than a lower limit value of the voltage required for the normal operation of the pixel driving circuit;
the protection sub-circuit is configured to: control the external power supply signal to be output to the pixel driving circuit in a case that a voltage of the external power supply signal is within a range of the voltages required for the normal operation; control the external power supply signal to be output from the first power supply terminal in a case that the voltage of the external power supply signal is not within the range of the voltages required for the normal operation and greater than the voltage of the first power supply signal; and control the external power supply signal to be output to the external power supply in a case that the voltage of the external power supply signal is not within the range of the voltages required for the normal operation and less than the voltage of the second power supply signal;
the control sub-circuit is configured to: transmit a switch control signal at a first potential to the control terminal of the switch sub-circuit based on the first power supply signal, the second power supply signal, and the external power supply signal in a case that a current of the external power supply signal is not within a range of currents required for the normal operation of the pixel driving circuit; and transmit a switch control signal at a second potential to the control terminal of the switch sub-circuit based on the first power supply signal, the second power supply signal, and the external power supply signal in a case that the current of the external power supply signal is within the range of the currents required for the normal operation of the pixel driving circuit; and
the switch sub-circuit is configured to: control the external power supply to be disconnected to the pixel driving circuit based on the switch control signal at the first potential, and control the external power supply to be connected to the pixel driving circuit based on the switch control signal at the second potential.

18. The display apparatus according to claim 16, wherein the protection sub-circuit comprises: an overvoltage protection diode and an undervoltage protection diode;
wherein a positive electrode of the overvoltage protection diode is coupled to the first electrode of the external power supply, and a negative electrode of the overvoltage protection diode is coupled to the first power supply terminal; and
a positive electrode of the undervoltage protection diode is coupled to the second electrode of the external power supply, and both the positive electrode of the undervoltage protection diode and the second electrode of the external power supply are coupled to the second power supply terminal.

19. The display apparatus according to claim 16, wherein the control sub-circuit comprises: a detecting unit and a primary feedback unit;
wherein two terminals of the detecting unit are respectively coupled to the first electrode of the external power supply and the input terminal of the switch sub-circuit, and the detecting unit is configured to detect a current of the external power supply signal; and
the primary feedback unit is coupled to the two terminals of the detecting unit, the first power supply terminal, the second power supply terminal, and a control terminal of the switch sub-circuit, and the primary feedback unit is configured to generate a switch control signal based on the first power supply signal, the second power supply signal, and the current of the external power supply signal, and transmit the switch control signal to the control terminal of the switch sub-circuit.

20. The display apparatus according to claim 19, wherein the detecting unit comprises:
a sampling resistor;
wherein a first end of the sampling resistor is coupled to the first electrode of the external power supply, and a second end of the sampling resistor is coupled to the input terminal of the switch sub-circuit.
